(19) United States
(12) Patent Application Publication
(10) Pub. No.: US 2022/0366307 A1
(43) Pub. Date: Nov. 17, 2022

(54) LEARNING DEVICE, PREDICTION DEVICE, LEARNING METHOD, AND LEARNING PROGRAM

(71) Applicant: NIPPON TELEGRAPH AND TELEPHONE CORPORATION, Tokyo (JP)

(72) Inventors: Koshin TO, Tokyo (JP); Masaru MIYAMOTO, Tokyo (JP); Shinya OI, Tokyo (JP); Akira NAKAYAMA, Tokyo (JP); Yusuke TANAKA, Tokyo (JP); Takayuki ADACHI, Tokyo (JP); Mitsutoshi NAGAHAMA, Tokyo (JP); Maiko NAYA, Tokyo (JP)

(73) Assignee: NIPPON TELEGRAPH AND TELEPHONE CORPORATION, Tokyo (JP)

(21) Appl. No.: 17/763,409

(22) PCT Filed: Oct. 2, 2019
(86) PCT No.: PCT/JP2019/038930

§ 371 Date: Mar. 24, 2022

(51) Int. Cl. G06N 20/00; G08G 9/00

(52) U.S. Cl. CPC G06N 20/00; G08G 9/00

(57) ABSTRACT

A first learning unit (101) learns a difference model (111) for predicting a difference between current monitoring data that is monitoring data obtained by monitoring a monitoring target at each time point and at each of a plurality of monitoring points and is monitoring data at a current time point, and past monitoring data that is monitoring data at each of a plurality of past time points; a second learning unit (102) learns a prediction model (past) (112) for predicting variation of the monitoring target using the past monitoring data; a first generation unit (103) generates corrected past data using the difference model (111), by correcting a difference between the past monitoring data and the current monitoring data; and a third learning unit (104) learns a prediction model (current) (113) for predicting variation of the monitoring target using the current monitoring data, the difference model (111), the prediction model (past) (112), and the corrected past data, whereby variation of the monitoring target can be appropriately predicted even when the monitoring target involves irregular variation.

### TECHNICAL FIELD

The disclosed techniques relate to a learning apparatus, a prediction apparatus, a learning method, and a learning program.

### BACKGROUND ART

There have been attempts to predict a flow of human traffic in the future (after a time point T) and simulate a flow of human traffic in the past, based on data obtained by measuring the number of people passing through a plurality of monitoring points and the number of people within a monitoring area.

For example, techniques using LONG SHORT-TERM MEMORY, Markov chain (LSTM), and the like have been proposed for predicting a flow of human traffic (NPL 1 and 2).

Furthermore, there is a technique of setting a walk model for a movement (walking) of people, and predicting the movement of people assuming that the people moves along the walk model. For example, a walk model has been proposed using, as parameters, acceleration force toward ideal speed, repulsion from environments such as walls, and attraction force from others, objects, and the like (NPL 3).

Furthermore, a technique has been proposed for predicting movement of a target object (such as human), with the target moving to an adjacent cell or staying where he or she is under a predetermined rule within each area segmented by cells (NPL 4).

### CITATION LIST

### Non Patent Literature

NPL 1: S. Hochreiter, et al. “LONG SHORT-TERM MEMORY”, Neural computation, 9.8, (1997), p. 1735 to 1780.
NPL 2: C. J. Geyer, “Practical Markov Chain in Monte Carlo”, Statistical science vol. 7 No. 4, (1992), p. 473 to 483.
NPL 3: D. Helbing, P. Molnar, “Social force model for pedestrian dynamics”, Physical Review E 51, (1995), p. 4282 to 4286.
NPL 4: K. Nagel, M. Schreckenberg, “A cellular automaton model for freeway traffic”, Journal de Physique I, EDP Sciences, (1992), p. 2221 to 2229.

### SUMMARY OF THE INVENTION

### Technical Problem

With the related-art techniques, a flow of human traffic can be appropriately predicted as long as the monitoring target makes regular variation in the past and at the current time point. However, there is a problem in that the accuracy of the prediction is compromised if the monitoring target involves an irregular variation.

The disclosed technique has been made in view of the above, and an object of the disclosure is to appropriately predict the variation of a monitoring target even when the monitoring target involves irregular variation.

### Means for Solving the Problem

According to a first aspect of the present disclosure, a learning apparatus includes: a first learning unit configured to learn a first model for predicting a difference between current monitoring data that is monitoring data obtained by monitoring a monitoring target at each time point and at each of a plurality of monitoring points and is monitoring data at a current time point, and past monitoring data that is monitoring data at each of a plurality of past time points; a second learning unit configured to learn a second model for predicting variation of the monitoring target using the past monitoring data; a first generation unit configured to generate first corrected data from the past monitoring data, by correcting a difference between the past monitoring data and the current monitoring data, using the first model; and a third learning unit configured to learn a third model for predicting variation of the monitoring target using the current monitoring data, the first model, the second model, and the first corrected data.

According to a second aspect of the present disclosure, a learning apparatus includes: a first learning unit configured to learn a first model for predicting a difference between current monitoring data that is monitoring data obtained by monitoring a monitoring target at each time point and at each of a plurality of monitoring points and is monitoring data at a current time point, and estimation data obtained by estimating monitoring data at each of a plurality of time points; a fourth learning unit configured to learn a fourth model for predicting variation of the monitoring target using the estimation data; a second generation unit configured to generate second corrected data from the estimation data, by correcting a difference between the estimation data and the current monitoring data, using the first model; and a third learning unit configured to learn a third model for predicting variation of the monitoring target using the current monitoring data, the first model, the fourth model, and the second corrected data.

According to a third aspect of the present disclosure, a prediction apparatus includes: a first prediction unit configured to predict, using a first model, a difference between current monitoring data that is monitoring data obtained by monitoring a monitoring target at each time point and at each of a plurality of monitoring points, and is monitoring data at a current time point and past monitoring data that is monitoring data at each of a plurality of past time points; a second prediction unit configured to predict, using a second model, variation of the monitoring target from the past monitoring data; a first generation unit configured to generate first corrected data from the past monitoring data, by correcting a difference between the past monitoring data and the current monitoring data, using the first model; and a third prediction unit configured to predict, using a third model, variation of the monitoring target from the current monitoring data, the first model, the second model, and the first corrected data.

According to a fourth aspect of the present disclosure, a prediction apparatus includes: a first prediction unit configured to predict, using a first model, a difference between current monitoring data that is monitoring data obtained by monitoring a monitoring target at each time point and at each of a plurality of monitoring points and is monitoring data at a current time point, and estimation data obtained by estimating monitoring data at each of a plurality of time points; a fourth prediction unit configured to predict, using a fourth model, variation of the monitoring target from the estimation data; a second generation unit configured to generate second corrected data from the estimation data, by correcting a difference between the estimation data and the current monitoring data, using the first model; and a third prediction unit configured to predict, using a third model, variation of the monitoring target from the current monitoring data, the first model, the fourth model, and the second corrected data.

According to a fifth aspect of the present disclosure, a learning method performed by a learning apparatus that includes a first learning unit, a second learning unit, a first generation unit, and a third learning unit includes: learning, at the first learning unit, a first model for predicting a difference between current monitoring data that is monitoring data obtained by monitoring a monitoring target at each time point and at each of a plurality of monitoring points, and is monitoring data at a current time point and past monitoring data that is monitoring data at each of a plurality of past time points; learning, at the second learning unit, a second model for predicting variation of the monitoring target using the past monitoring data; generating, at the first generation unit, first corrected data from the past monitoring data, by correcting a difference between the past monitoring data and the current monitoring data, using the first model; and learning, at the third learning unit, a third model for predicting variation of the monitoring target using the current monitoring data, the first model, the second model, and the first corrected data.

According to a sixth aspect of the present disclosure, a learning method performed by a learning apparatus that includes a first learning unit, a fourth learning unit, a second generation unit, and a third learning unit includes: learning, at the first learning unit, a first model for predicting a difference between current monitoring data that is monitoring data obtained by monitoring a monitoring target at each time point and at each of a plurality of monitoring points and is monitoring data at a current time point, and estimation data obtained by estimating monitoring data at each of a plurality of time points; learning, at the fourth learning unit, a fourth model for predicting variation of the monitoring target using the estimation data; generating, at the second generation unit, second corrected data from the estimation data, by correcting a difference between the estimation data and the current monitoring data, using the first model; and learning, at the third learning unit, a third model for predicting variation of the monitoring target using the current monitoring data, the first model, the fourth model, and the second corrected data.

According to a seventh aspect of the present disclosure, a learning program causes a computer to function as: a first learning unit configured to learn a first model for predicting a difference between current monitoring data that is monitoring data obtained by monitoring a monitoring target at each time point and at each of a plurality of monitoring points and is monitoring data at a current time point, and past monitoring data that is monitoring data at each of a plurality of past time points; a second learning unit configured to learn a second model for predicting variation of the monitoring target using the past monitoring data; a first generation unit configured to generate first corrected data from the past monitoring data, by correcting a difference between the past monitoring data and the current monitoring data, using the first model; and a third learning unit configured to learn a third model for predicting variation of the monitoring target using the current monitoring data, the first model, the second model, and the first corrected data.

### Effects of the Invention

With the disclosed techniques, variation of the monitoring target can be appropriately predicted even if monitoring data obtained by monitoring a monitoring target is largely different from past monitoring data.

### BRIEF DESCRIPTION OF DRAWINGS

FIG. 1 is a block diagram illustrating a hardware configuration of a prediction apparatus.

FIG. 2 is a block diagram illustrating an example of functional components of a prediction apparatus.

FIG. 3 is a schematic diagram illustrating a difference in monitoring data and variation of monitoring target between a regular condition and an irregular condition.

FIG. 4 is a flowchart illustrating a flow of a learning process according to a first embodiment.

FIG. 5 is a flowchart illustrating a flow of a prediction process according to the first embodiment.

FIG. 6 is a flowchart illustrating a flow of a learning process according to a second embodiment.

FIG. 7 is a flowchart illustrating a flow of a prediction process according to the second embodiment.

FIG. 8 is a flowchart illustrating a flow of a learning process according to a third embodiment.

FIG. 9 is a flowchart illustrating a flow of a prediction process according to the third embodiment.

### DESCRIPTION OF EMBODIMENTS

Hereinafter, one example of the embodiments of the disclosed technique will be described with reference to the drawings. In the drawings, the same reference numerals are given to the same or equivalent constituent elements and parts. The dimensional ratios in the drawings are exaggerated for convenience of explanation and may differ from the actual ratios.

### First Embodiment

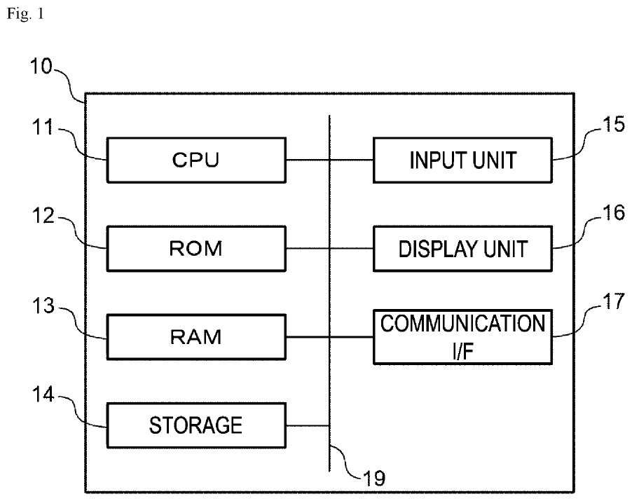

FIG. 1 is a block diagram illustrating a hardware configuration of a prediction apparatus 10 according to a first embodiment.

As illustrated in FIG. 1, the prediction apparatus 10 includes a central processing unit (CPU) 11, a read only memory (ROM) 12, a random access memory (RAM) 13, a storage 14, an input unit 15, a display unit 16, and a communication interface (I/F) 17. The components are communicably interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic processing operations in accordance with a program stored in the ROM 12 or the storage 14. In the present embodiment, a prediction program for executing a learning process and a prediction process described later is stored in the ROM 12 or the storage 14.

The ROM 12 stores various programs and various kinds of data. The RAM 13 is a work area that temporarily stores a program or data. The storage 14 is constituted by a storage device such as a hard disk drive (HDD) or a solid state drive (SSD) and stores various programs including an operating system and various kinds of data.

The input unit 15 includes a pointing device such as a mouse and a keyboard and is used for performing various inputs.

The display unit 16 is, for example, a liquid crystal display and displays various kinds of information. The display unit 16 may employ a touch panel system and function as the input unit 15.

The communication I/F 17 is an interface for communicating with other devices and, for example, uses a standard such as Ethernet (registered trade name), FDDI, or Wi-Fi (registered trade name).

Next, a functional component of the prediction apparatus 10 will be described.

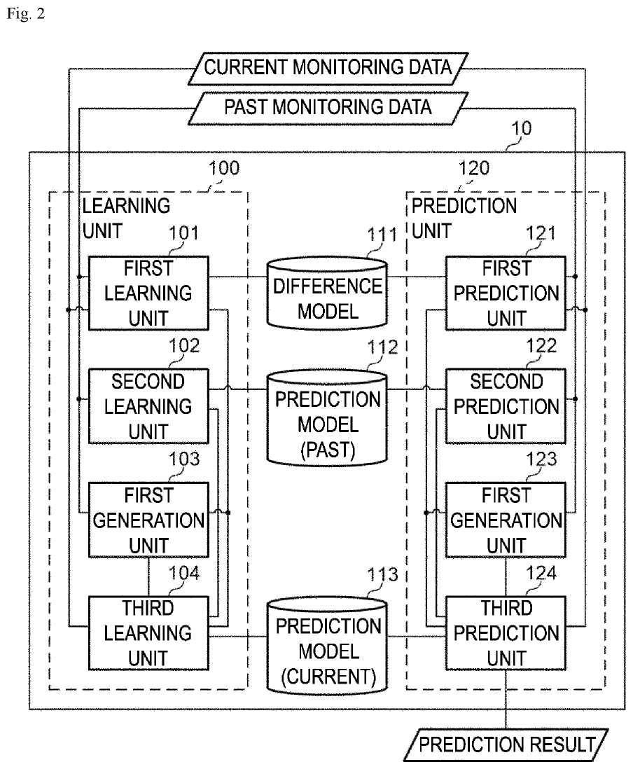

FIG. 2 is a block diagram illustrating an example of functional components of the prediction apparatus 10. The prediction apparatus 10 receives current monitoring data that is monitoring data obtained by monitoring a monitoring target at each of a plurality of monitoring points at each time point and is monitoring data at the current time point, and past monitoring data that is monitoring data at each of a plurality of time points in the past. The monitoring data at each time point is, for example, data at the time point that can be used to predict a variation of a monitoring target, such as, for example, the number of monitoring targets passing through each of the plurality of locations and the number of monitoring targets in each area. The monitoring data is acquired based on, for example, sensor data detected by various sensors and images captured by a camera. The monitoring data may be manually monitored data obtained by using a number detector or the like.

In the present embodiment, monitoring data at each of time points T1, T2, . . . , TN, TN+1, . . . is input at the time of learning, and among these, the monitoring data at the time point TN is the current monitoring data and monitoring data before the time point TN is the past monitoring data. Note that the monitoring data at and after the time point TN+1 is used as correct data when learning various models described later. A plurality of combinations of the current monitoring data and the past monitoring data are assumed to be input, with a plurality of different values of N set. Furthermore, it is assumed that at the time of prediction, the monitoring data at the time point TM is input as the current monitoring data, and monitoring data before the time point TM is input as the past monitoring data.

Now, differences in the monitoring data and variation of the monitoring target between a regular condition and irregular condition will be described.

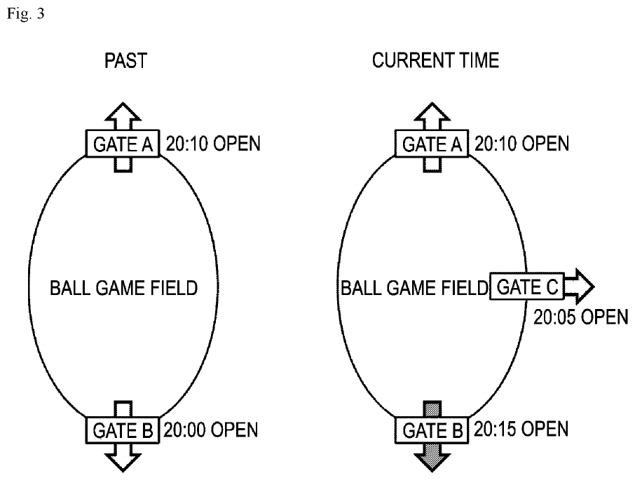

For example, as illustrated in FIG. 3, a case is considered where a prediction is made with a variation of the number of people passing through each gate in each time slot regarded as a variation of the monitoring target, where the monitoring target is a person entering and exiting into and from a predetermined area such as a ball game field through the gate, and the monitoring data is the number of people passing through each gate at each time point.

As illustrated on the left side in FIG. 3, under the regular condition, it is assumed that a gate A opens at 20:10, a gate B opens at 20:00, and the past monitoring data have been acquired under this condition. On the other hand, as illustrated in the right side in FIG. 3, it is assumed that, under the current condition, the gate A opens at 20:10, the gate B opens at 20:15, and a gate C opens at 20:05. In such a case, the time when the gate B opens is different from that under the condition where the past monitoring data has been acquired. Furthermore, the gate C opens, which is an event that did not occur when the past monitoring data was monitored. As a result, there is a huge difference in the number of people passing through each gate. Thus, the current condition can be regarded as the irregular condition involving variation of the monitoring target different from that under the regular condition described above.

As another example, assuming a situation where a facility that can accommodate a large number of people is located around a station, the regular condition corresponds to a day or a time slot in which no event is held in the facility, and the irregular condition corresponds to a day or a time slot in which an event is held. In this case, the variation of the monitoring target, such as the number of people in each route between the station and the facility under the irregular condition largely differs from that under the regular condition.

Under such conditions described above, prediction of variation of the monitoring target at a time point that is in the future from the current time point under the irregular condition, based on the past monitoring data observed under the regular condition results in low prediction accuracy.

In view of this, in the present embodiment, appropriate prediction suitable for the current condition is made with a difference between the past monitoring data and the current monitoring data reflected on the prediction of the variation of the monitoring target. Functional components of the prediction apparatus 10 will be described below.

As illustrated in FIG. 2, the prediction apparatus 10 includes a learning unit 100 and a prediction unit 120 as functional components. The learning unit 100 further includes a first learning unit 101, a second learning unit 102, a first generation unit 103, and a third learning unit 104. The prediction unit 120 further includes a first prediction unit 121, a second prediction unit 122, a first generation unit 123, and a third prediction unit 124. Furthermore, a difference model 111, a prediction model (past) 112, and a prediction model (current) 113 are stored in a predetermined storage region of the prediction apparatus 10.

Each functional component is realized by the CPU 11 reading a prediction program stored in the ROM 12 or the storage 14, loading the prediction program onto the RAM 13 to execute the prediction program. Note that the learning unit 100 is an example of a learning apparatus of the disclosed technique, and each of the prediction unit 120 and the prediction apparatus 10 is an example of a prediction apparatus of the disclosed technique.

The first learning unit 101 learns the difference model 111 to predict a difference between the current monitoring data and the past monitoring data. Specifically, the difference model 111 extracts an attribute that quantitatively indicates a difference between the input current monitoring data and the past monitoring data, and outputs, based on the extracted attribute, a prediction result indicating that the current condition is the regular condition or the irregular condition. Note that the difference model 111 is an example of a first model of the disclosed technique.

For example, the first learning unit 101 prepares, as training data, a plurality of pairs of current monitoring data (monitoring data at the time point TN) under each of the regular condition and the irregular condition, and the past monitoring data at a plurality of time points (the monitoring data at time points T1, T2, . . . , and Tn (n<N)). Furthermore, the first learning unit 101 extracts, as a difference attribute, an attribute quantitatively indicating the difference between the pairs. Examples of the attribute include the average, variance, and the like of the difference between the current monitoring data and each of the past monitoring data at a plurality of time points, and the attribute obtained during the learning stage according to a learning algorithm. Then, the first learning unit 101 learns parameters of the difference model 111, with the difference attribute extracted for each of the plurality of time points TN associated with a correct label indicating the regular condition or the irregular condition as the condition at the time point TN.

The first learning unit 101 stores the difference model 111, the parameters of which have been learned, in a predetermined storage region. The first learning unit 101 passes the difference attribute at each time point TN that is extracted during learning to each of the first generation unit 103 and the third learning unit 104.

Using the past monitoring data, the second learning unit 102 learns the prediction model (past) 112 for predicting the variation of the monitoring target. The prediction model (past) 112 outputs, based on the past monitoring data input, a variation of the monitoring target such as the number of monitoring targets in each location, each time slot, each route, or the like at a future time point, as a prediction result. Note that the prediction model (past) 112 is an example of a second model of the disclosed technique.

For example, the second learning unit 102 uses, as an input to the prediction model (past) 112, the past monitoring data at the time points T1, T2, . . . , and Tn (n<N) among the past monitoring data. Then, the second learning unit 102 learns the parameters of the prediction model (past) 112 so that the prediction result for each of time points TN, TN+1, . . . matches the variation of the monitoring target identified based on the past monitoring data at each of the time points TN, TN+1, . . . .

The second learning unit 102 stores the prediction model (past) 112, the parameters of which have been learned, in a predetermined storage region. The second learning unit 102 passes the learned parameters of the prediction model (past) 112 to the third learning unit 104.

The first generation unit 103 generates corrected past data from the past monitoring data by correcting the difference between the past monitoring data and the current monitoring data, using the difference attribute received from the first learning unit 101. For example, when the average and the variance of the difference described above are extracted as the difference attribute, the first generation unit 103 adds of subtracts a value based on the average and variance, which is the difference attribute at the time point TN, to or from the past monitoring data at each of the time points T1, T2, . . . , and Tn (n<N). As a result, the corrected past data is generated by the first generation unit 103. The first generation unit 103 passes the corrected past data thus generated to the third learning unit 104.

The third learning unit 104 acquires the current monitoring data, the difference attribute received from the first learning unit 101, the parameter of the prediction model (past) 112 received from the second learning unit 102, and the corrected past data received from the first generation unit 103. Then, the third learning unit 104 learns the prediction model (current) 113 for predicting variation of the monitoring target using the acquired information.

Specifically, the third learning unit 104 identifies corrected past data generated from past monitoring data at the time point T1, T2, . . . , and Tn (n<N) and corresponding to the time point TN associated with the correct label indicating the irregular condition, and uses the corrected past data as an input to the prediction model (current) 113. Then, the third learning unit 104 learns the parameters of the prediction model (estimate) 113 so that the prediction result for each of time points TN, TN+1, . . . matches the variation of the monitoring target identified based on the past monitoring data at each of the time points TN, TN+1, . . . . In this case, the third learning unit 104 can also use the difference attribute at the time point TN as the training data. The third learning unit 104 may learn the parameters of the prediction model (current) 113 to adjust the parameters of the prediction model (past) 112. The third learning unit 104 stores the prediction model (current) 113, the parameters of which have been learned, in a predetermined storage region.

The first prediction unit 121 predicts a difference between the current monitoring data and the past monitoring data using the difference model 111. Specifically, the first prediction unit 121 inputs the current monitoring data at the time point TM and the past monitoring data at the time points T1, T2, . . . , and Tm (m<M) to the difference model 111, and obtains a prediction result, output from the difference model 111, indicating that the current condition is the regular condition or the irregular condition. Furthermore, the first prediction unit 121 acquires the difference attribute extracted by the difference model 111 in the prediction process for predicting whether the current condition is the regular condition or the irregular condition. The first prediction unit 121 passes the acquired prediction result and the difference attribute to each of the first generation unit 123 and the third prediction unit 124.

The second prediction unit 122 uses the prediction model (past) 112 to predict variation of the monitoring target at a future time point from the past monitoring data, and passes the prediction result to the third prediction unit 124. Specifically, the second prediction unit 122 inputs the past monitoring data at the time points T1, T2, . . . , and Tm (m<M) to the prediction model (past) 112, and acquires the prediction result for the variation of the monitoring target at the time points TM+1, TM+2, . . . , output from the prediction model (past) 112. The second prediction unit 122 passes the acquired prediction result to the third prediction unit 124.

The first generation unit 123 generates corrected past data from the past monitoring data by correcting the difference between the past monitoring data and the current monitoring data, using the difference attribute received from the first prediction unit 121. For example, the first generation unit 123 adds or subtracts the value based on the average and variance, which is the difference attribute at the time point TM, to or from the past monitoring data at each of the time points T1, T2, . . . , and Tm (m<N) to generate the corrected past data. The first generation unit 123 passes the corrected past data thus generated to the third prediction unit 124.

The third prediction unit 124 acquires the current monitoring data, the prediction result and the difference attribute received from the first prediction unit 121, the prediction result received from the second prediction unit 122, and the corrected past data received from the first generation unit 123. The third prediction unit 124 uses the acquired information and the prediction model (current) 113 to predict the variation of the monitoring target at a future time point.

Specifically, when the prediction result received from the first prediction unit 121 indicates the irregular condition, the third prediction unit 124 inputs the current monitoring data at the time point TM, the corrected past data for the time points T1, T2, . . . , and Tm (m<N), and the difference attribute at the time point TM into the prediction model (current) 113. Then, the third prediction unit 124 outputs the prediction result output from the prediction model (current) 113 as the final prediction result. When the prediction result received from the first prediction unit 121 indicates the regular condition, the third prediction unit 124 outputs the prediction result received from the second prediction unit 122 as the final prediction result.

Next, an operation the prediction apparatus 10 will be described.

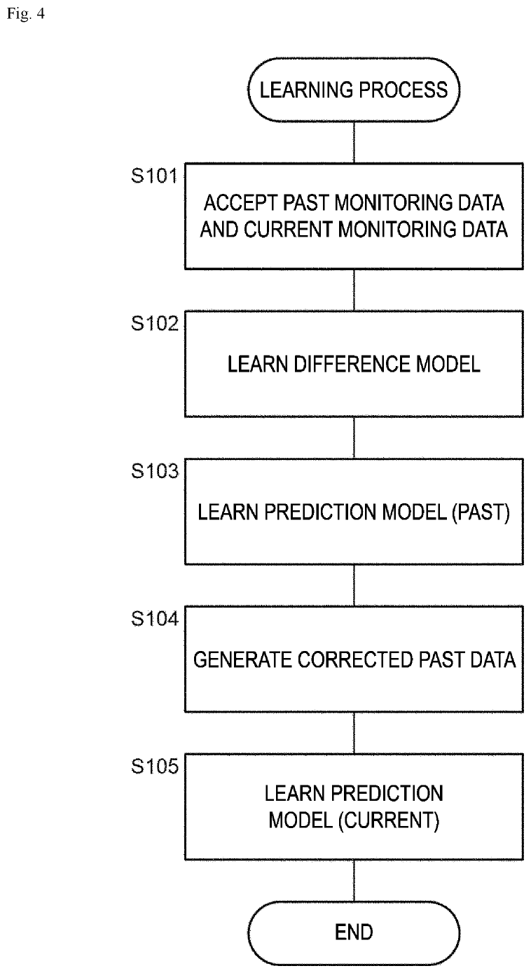

FIG. 4 is a flowchart illustrating a sequence of the learning process performed by the prediction apparatus 10. The CPU 11 reads the prediction program from the ROM 12 or the storage 14, loads the prediction program onto the RAM 13, and executes the prediction program, to perform the learning process.

In step S101, the CPU 11 operates as the learning unit 100, and accepts current monitoring data and past monitoring data input to the prediction apparatus 10.

Next, in step S102, the CPU 11 operates as the first learning unit 101, and learns the difference model 111 to predict a difference between the current monitoring data and the past monitoring data. Then, the CPU 11 operates as the first learning unit 101, and stores the difference model 111, the parameters from which has been learned, in a predetermined storage region, and passes the difference attribute extracted during the learning to each of the first generation unit 103 and the third learning unit 104.

Next, in step S103, the CPU 11 operates as the second learning unit 102 and learns the prediction model (past) 112 to predict the variation of the monitoring target using the past monitoring data. Then, the CPU 11 operates as the second learning unit 102, and stores the prediction model (past) 112, the parameters of which have been learned, in a predetermined storage region, and passes the learned parameters of the prediction model (past) 112 to the third learning unit 104.

Next, in step S104, the CPU 11 operates as the first generation unit 103, and generates corrected past data from the past monitoring data by correcting the difference between the past monitoring data and the current monitoring data, using the difference attribute received from the first learning unit 101. Then, the CPU 11 operates as the first generation unit 103 and passes the corrected past data thus generated to the third learning unit 104.

Next, in step S105, the CPU 11 operates as the third learning unit 104 and acquires the current monitoring data, the difference attribute received from the first learning unit 101, the parameter of the prediction model (past) 112 received from the second learning unit 102, and the corrected past data received from the first generation unit 103. Then, the CPU 11 operates as the third learning unit 104, and learns the prediction model (current) 113 for predicting variation of the monitoring target using the acquired information. Then, the CPU 11 operates as the third learning unit 104, and stores the prediction model (current) 113, the parameters of which have been learned, in a predetermined storage region, and the learning process ends.

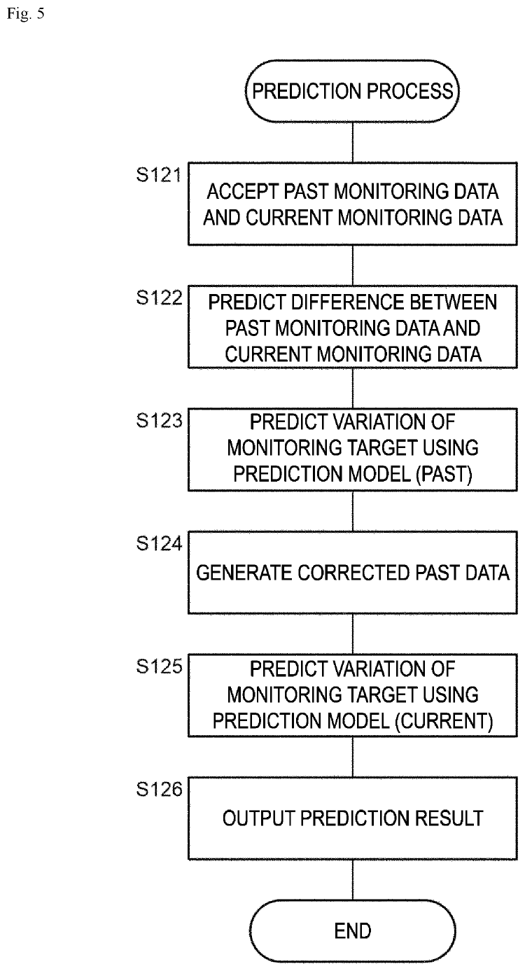

FIG. 5 is a flowchart illustrating a sequence of the prediction process performed by the prediction apparatus 10. The CPU 11 reads the prediction program from the ROM 12 or the storage 14, loads the prediction program onto the RAM 13, and executes the prediction program, to execute the prediction process.

In step S121, the CPU 11 operates as the prediction unit 120, and accepts current monitoring data and past monitoring data input to the prediction apparatus 10.

Next, in step S122, the CPU 11 operates as the first prediction unit 121, and predicts the difference between the current monitoring data and the past monitoring data using the difference model 111. Specifically, the CPU 11 operates as the first prediction unit 121, and inputs the current monitoring data and the past monitoring data to the difference model 111, and obtains a prediction result, output from the difference model 111, indicating that the current condition is the regular condition or the irregular condition. Then, the CPU 11 operates as the first prediction unit 121, and passes to each of the first generation unit 123 and the third prediction unit 124, the difference attribute extracted by the difference model 111 during the prediction process for predicting whether the current condition is the regular condition or the irregular condition as well as the prediction result.

Next, in step S123, the CPU 11 operates as the second prediction unit 122, and uses the prediction model (past) 112 to predict variation of the monitoring target at a future time point from the past monitoring data, and passes the prediction result to the third prediction unit 124.

Next, in step S124, the CPU 11 operates as the first generation unit 123, and generates corrected past data from the past monitoring data by correcting the difference between the past monitoring data and the current monitoring data, using the difference attribute received from the first prediction unit 121. Then, the CPU 11 operates as the first generation unit 123 and passes the corrected past data thus generated to the third prediction unit 124.

Next, in step S125, the CPU 11 operates as the third prediction unit 124, and acquires the current monitoring data, the prediction result and the difference attribute received from the first prediction unit 121, the prediction result received from the second prediction unit 122, and the corrected past data received from the first generation unit 123. Then, the CPU 11 operates as the third prediction unit 124, and predicts the variation of the monitoring target at a future time point using the acquired information and the prediction model (current) 113, when the prediction result received from the first prediction unit 121 indicates the irregular condition.

Next, in step S126, the CPU 11 operates as the third prediction unit 124, and outputs the prediction result output from the prediction model (current) 113 as the final prediction result. The CPU 11 operates as the third prediction unit 124, and outputs the prediction result received from the second prediction unit 122 as the final prediction result, when the prediction result received from the first prediction unit 121 indicates the regular condition, and the prediction process ends.

As described above, the prediction apparatus according to the first embodiment learns in advance, a difference model for predicting whether the current condition is the regular condition or the irregular condition based on the difference between the past monitoring data and the current monitoring data. The corrected past data is generated as a result of correcting the difference between the past monitoring data and the current monitoring data, and the prediction model (current) for predicting the variation of the monitoring target is learned using the corrected past data. Then, when the current condition is predicted to be the irregular condition by the prediction, the corrected past data is generated and the corrected past data and the prediction model (current) are used to predict the variation of the monitoring target. With this configuration, the variation of the monitoring target can be appropriately predicted even when the monitoring target involves irregular variation.

### Second Embodiment

Next, a second embodiment will be described. In a prediction apparatus according to the second embodiment, components that are the same as those in the prediction apparatus 10 according to the first embodiment will be denoted by the same reference numerals, and the detailed description thereof will be omitted. The hardware configuration of the prediction apparatus according to the second embodiment is similar to the hardware configuration of the prediction apparatus 10 according to the first embodiment illustrated in FIG. 1, and thus description thereof will be omitted.

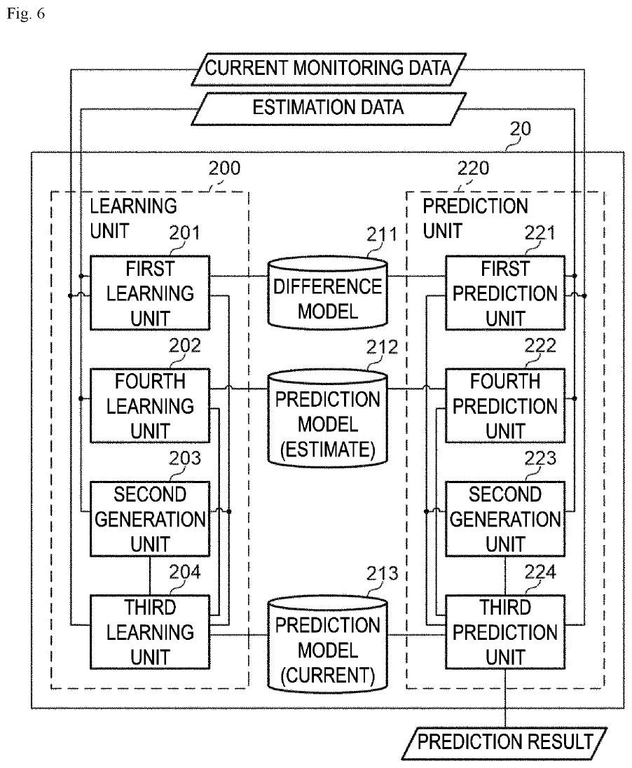

FIG. 6 is a block diagram illustrating an example of functional components of a prediction apparatus 20 according to the second embodiment. Current monitoring data and estimation data as a result of estimating monitoring data at each of a plurality of time points are input to the prediction apparatus 20. The estimation data is, for example, data obtained by simulating monitoring data using a simulator or the like.

As illustrated in FIG. 6, the prediction apparatus 20 includes a learning unit 200 and a prediction unit 220 as functional components. The learning unit 200 further includes a first learning unit 201, a fourth learning unit 202, a second generation unit 203, and a third learning unit 204. The prediction unit 220 further includes a first prediction unit 221, a fourth prediction unit 222, a second generation unit 223, and a third prediction unit 224. Furthermore, a difference model 211, a prediction model (estimate) 212, and a prediction model (current) 213 are stored in a predetermined storage region of the prediction apparatus 20.

Each functional component is realized by the CPU 11 reading a prediction program stored in the ROM 12 or the storage 14, loading the prediction program onto the RAM 13 to execute the prediction program.

The first learning unit 201 learns the difference model 211 to predict a difference between the current monitoring data and the estimation data. Note that the difference model 211 is an example of a first model of the disclosed technique.

Using the estimation data, the fourth learning unit 202 learns the prediction model (estimate) 212 for predicting the variation of the monitoring target. Note that the prediction model (estimate) 212 is an example of a fourth model of the disclosed technique.

The second generation unit 203 generates corrected estimation data from the estimation data by correcting the difference between the estimation data and the current monitoring data, using the difference attribute received from the first learning unit 201.

The third learning unit 204 acquires the current monitoring data, the difference attribute received from the first learning unit 201, the parameter of the prediction model (estimate) 212 received from the fourth learning unit 202, and the corrected estimation data received from the second generation unit 203. Then, the third learning unit 204 learns the prediction model (current) 213 for predicting variation of the monitoring target using the acquired information.

The first prediction unit 221 predicts a difference between the current monitoring data and the estimated monitoring data using the difference model 211.

The fourth prediction unit 222 uses the prediction model (estimate) 212 to predict variation of the monitoring target at a future time point from the estimation data.

The second generation unit 223 generates corrected estimation data from the estimation data by correcting the difference between the estimation data and the current monitoring data, using the difference attribute received from the first prediction unit 221.

The third prediction unit 224 acquires the current monitoring data, the prediction result and the difference attribute received from the first prediction unit 221, the prediction result received from the fourth prediction unit 222, and the corrected estimation data received from the second generation unit 223. The third prediction unit 224 uses the acquired information and the prediction model (current) 213 to predict the variation of the monitoring target at a future time point.

For the specific process method for each functional component, “past monitoring data”, “corrected past data”, and “prediction model (past)” in the specific process of the functional components of the prediction apparatus 10 according to the first embodiment may be replaced with “estimation data,” “corrected estimation data,” and “prediction model (estimate)”.

Also for the operation of the prediction apparatus 20 according to the second embodiment, the above replacement may be made in each of the learning process illustrated in FIG. 4 and the prediction process illustrated in FIG. 5, and thus the description thereof is omitted.

As described above, with the prediction apparatus according to the second embodiment in which the estimation data for estimating the monitoring data is used instead of the past monitoring data, the variation of the monitoring target can be appropriately predicted even when the variation of the monitoring target is irregular as in the first embodiment.

### Third Embodiment

Next, a third embodiment will be described. In a prediction apparatus according to the third embodiment, components that are the same as those in the prediction apparatus 10 according to the first embodiment and the prediction apparatus 20 according to the second embodiment will be denoted by the same reference numerals, and the detailed description thereof will be omitted. The hardware configuration of the prediction apparatus according to the third embodiment is similar to the hardware configuration of the prediction apparatus 10 according to the first embodiment illustrated in FIG. 1, and thus description thereof will be omitted.

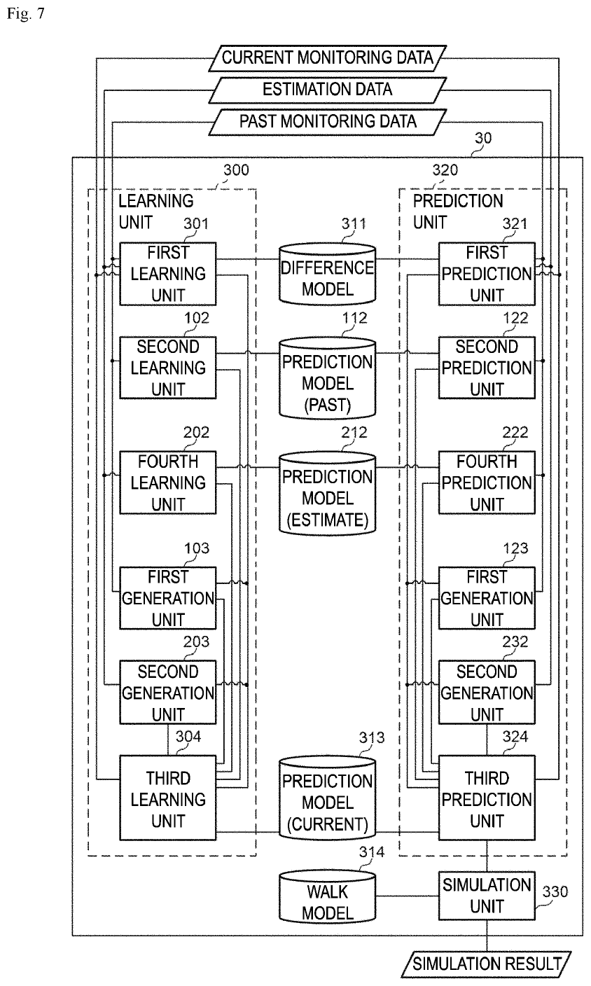

FIG. 7 is a block diagram illustrating an example of functional components of a prediction apparatus 30 according to the third embodiment. The current monitoring data, the past monitoring data, and the estimation data are input to the prediction apparatus 30.

As illustrated in FIG. 7, the prediction apparatus 30 includes a learning unit 300, a prediction unit 320, and a simulation unit 330 as functional components. The learning unit 300 further includes a first learning unit 301, the second learning unit 102, the fourth learning unit 202, the first generation unit 103, the second generation unit 203, and a third learning unit 304. The prediction unit 320 further includes a first prediction unit 321, the second prediction unit 122, the fourth prediction unit 222, the first generation unit 123, the second generation unit 223, and a third prediction unit 324. Furthermore, a difference model 311, the prediction model (past) 112, the prediction model (estimate) 212, a prediction model (current) 313, and a walk model 314 are stored in a predetermined storage region of the prediction apparatus 30.

Each functional component is realized by the CPU 11 reading a prediction program stored in the ROM 12 or the storage 14, loading the prediction program onto the RAM 13 to execute the prediction program.

The first learning unit 301 learns the difference model 311 to predict a difference between the current monitoring data, and the past monitoring data and the estimation data.

For example, the first learning unit 301 prepares, as training data, a plurality of pairs of current monitoring data (monitoring data at the time point TN) under each of the regular condition and the irregular condition, and the past monitoring data at a plurality of time points (the monitoring data at time points T1, T2, . . . , and Tn (n<N)). Similarly, the first learning unit 301 prepares, as training data, a plurality of pairs of current monitoring data (monitoring data at the time point TN) under each of the regular condition and the irregular condition, and the estimation data at a plurality of time points (the estimation data at time points T1, T2, . . . , and Tn (n<N)). Then, as in the case of the first learning unit 101 of the first embodiment, the first learning unit 301 learns the parameters of the difference model 311.

The first learning unit 301 stores the difference model 311, the parameters of have has been learned, in a predetermined storage region. The first learning unit 301 passes the difference attribute at each time point TN that is extracted during learning to each of the first generation unit 103, the second generation unit 203, and the third learning unit 304.

The third learning unit 304 acquires the current monitoring data, the difference attribute received from the first learning unit 101, the parameter of the prediction model (past) 112 received from the second learning unit 102, and the parameter of the prediction model (estimate) 212 received from the fourth learning unit 202. The third learning unit 304 acquires corrected past data received from the first generation unit 103 and corrected estimation data received from the second generation unit 203. Then, the third learning unit 304 learns the prediction model (current) 313 for predicting variation of the monitoring target using the acquired information.

Specifically, the third learning unit 304 identifies corrected past data generated from past monitoring data at the time point T1, T2, . . . , and Tn (n<N) and corresponding to the time point TN associated with the correct label indicating the irregular condition. Similarly, the third learning unit 304 identifies corrected estimation data generated from estimation data at the time point T1, T2, . . . , and Tn (n<N) and corresponding to the time point TN associated with the correct label indicating the irregular condition. The third learning unit 304 uses the corrected past data and the estimation data identified as input to the prediction model (current) 313. Then, the third learning unit 304 learns the parameters of the prediction model (current) 313 so that the prediction result for each of time points TN, TN+1, . . . matches the variation of the monitoring target identified based on the past monitoring data at each of the time points TN, TN+1, . . . . In this case, the third learning unit 304 can also use the difference attribute at the time point TN as the training data. The third learning unit 104 may learn the parameters of the prediction model (current) 313 to adjust the parameters of each of the prediction model (past) 112 and the prediction model (estimate) 212.

The first prediction unit 321 predicts a difference between the current monitoring data, and the past monitoring data and the estimation data using the difference model 311. Specifically, the first prediction unit 321 inputs the current monitoring data at the time point TM and each of the past monitoring data and the estimation data at the time points T1, T2, . . . , and Tm (m<M) to the difference model 311, and obtains a prediction result, output from the difference model 311, indicating that the current condition is the regular condition or the irregular condition. Furthermore, as in the case of the first prediction unit 121 of the first embodiment, the first prediction unit 321 acquires the difference attribute extracted by the difference model 311 during the prediction process for predicting whether the current condition is the regular condition or the irregular condition, and passes to each of the first generation unit 123, the second generation unit 223, and the third prediction unit 324, the difference attribute as well as the prediction result.

The third prediction unit 324 acquires the current monitoring data, the prediction result and the difference attribute received from the first prediction unit 321, the prediction result received from the second prediction unit 122, and the prediction result received from the fourth prediction unit 222. The third prediction unit 324 acquires corrected past data received from the first generation unit 123 and corrected estimation data received from the second generation unit 223. The third prediction unit 324 uses the acquired information and the prediction model (current) 313 to predict the variation of the monitoring target at a future time point.

Specifically, when the prediction result received from the first prediction unit 121 indicates the irregular condition, the third prediction unit 324 inputs the current monitoring data at the time point TM, the corrected past data and the corrected estimation data for the time points T1, T2, . . . , and Tm (m<N), and the difference attribute at the time point TM into the prediction model (current) 313. Then, the third prediction unit 324 outputs the prediction result output from the prediction model (current) 313 as the final prediction result.

When the prediction result received from the first prediction unit 121 indicates the regular condition, the third prediction unit 324 outputs the prediction result received from the second prediction unit 122, the prediction result received from the fourth prediction unit 222, or a prediction result as a result of combining these prediction results, as the final prediction result.

The walk model 314 is obtained by modeling how a pedestrian, which is an example of the monitoring target, walks. An existing model, such as the techniques described in NPL 3 and 4, can be used as the walk model 314. For the walk model 314, parameters for simulating how a pedestrian walks are set. Examples of the parameters include an accelerating force to be closer to an ideal speed, a repulsion from an environment such as a wall, attraction force from another person, an object, and the like.

The simulation unit 330 simulates how a pedestrian, which is an example of the monitoring target, walks, based on the prediction results for variation of the monitoring target output from the third prediction unit 324, and the walk model 314.

Specifically, the simulation unit 330 configures sets initial positions and the number of pedestrians based on the prediction results output from the third prediction unit 324. The simulation unit 330 moves each pedestrian thus set in accordance with the parameters of the walk model 314 to predict the movement of the pedestrian at a future time point or to simulate the movement of the pedestrian movement at a past time point. The simulation unit 330 outputs the simulation result.

Next, an operation the prediction apparatus 30 will be described.

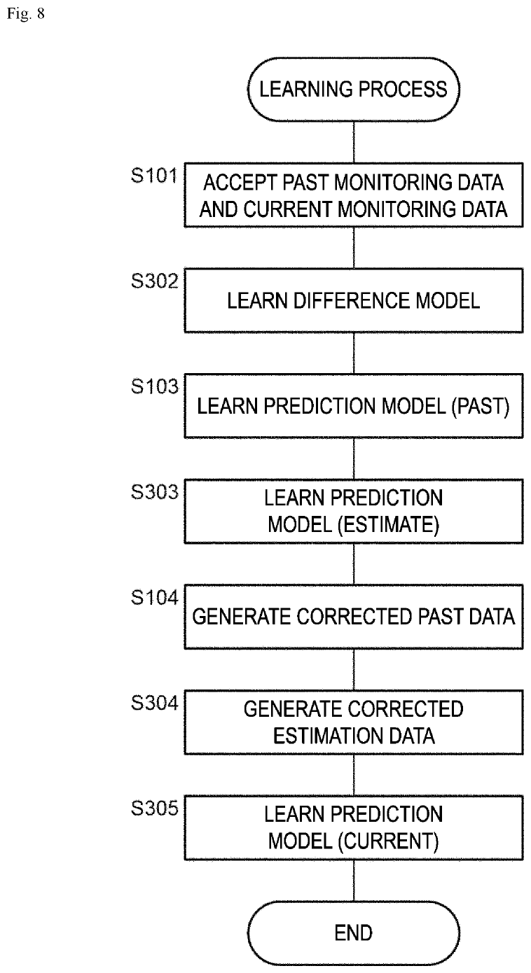

FIG. 8 is a flowchart illustrating a sequence of the learning process performed by the prediction apparatus 10. The CPU 11 reads the prediction program from the ROM 12 or the storage 14, loads the prediction program onto the RAM 13, and executes the prediction program, to perform the learning process. Note that the processes that are the same as those the learning process in the first embodiment (FIG. 4) are denoted by the same step numbers.

In step S101, the CPU 11 operates as the learning unit 300, and accepts current monitoring data and past monitoring data input to the prediction apparatus 30.

Next, in step S302, the CPU 11 operates as the first learning unit 301, and learns the difference model 311 to predict a difference between the current monitoring data and each of the past monitoring data and the estimation data. Then, the CPU 11 operates as the first learning unit 301, and stores the difference model 311, the parameters from which has been learned, in a predetermined storage region, and passes the difference attribute extracted during the learning to each of the first generation unit 103, the second generation unit 203, and the third learning unit 304.

Next, in step S103, the CPU 11 operates as the second learning unit 102 and learns the prediction model (past) 112 to predict the variation of the monitoring target using the past monitoring data. Then, the CPU 11 operates as the second learning unit 102, and stores the prediction model (past) 112, the parameters of which have been learned, in a predetermined storage region, and passes the learned parameters of the prediction model (past) 112 to the third learning unit 304.

Next, in step S303, the CPU 11 operates as the fourth learning unit 202 and learns the prediction model (estimate) 212 to predict the variation of the monitoring target using the estimation data. Then, the CPU 11 operates as the fourth learning unit 202, and stores the prediction model (estimate) 212, the parameters of which have been learned, in a predetermined storage region, and passes the learned parameters of the prediction model (estimate) 212 to the third learning unit 304.

Next, in step S104, the CPU 11 operates as the first generation unit 103, and generates corrected past data from the past monitoring data by correcting the difference between the past monitoring data and the current monitoring data, using the difference attribute received from the first learning unit 301. Then, the CPU 11 operates as the first generation unit 103 and passes the corrected past data thus generated to the third learning unit 304.

Next, in step S304, the CPU 11 operates as the second generation unit 203, and generates corrected estimation data from the estimation data by correcting the difference between the estimation data and the current monitoring data, using the difference attribute received from the first learning unit 301. Then, the CPU 11 operates as the second generation unit 203 and passes the corrected estimation data thus generated to the third learning unit 304.

Next, in step S305, the CPU 11 operates as the third learning unit 304, and acquires the current monitoring data and the difference attribute received from the first learning unit 301. The CPU 11 operates as the third learning unit 304, and acquires the parameter of the prediction model (past) 112 received from the second learning unit 102, and the parameter of the prediction model (estimate) 212 received from the fourth learning unit 202. The CPU 11 operates as the third learning unit 304, and acquires corrected past data received from the first generation unit 103 and corrected estimation data received from the second generation unit 203. Then, the CPU 11 operates as the third learning unit 304, and learns the prediction model (current) 313 for predicting variation of the monitoring target using the acquired information. Then, the CPU 11 operates as the third learning unit 304, and stores the prediction model (current) 313, the parameters of which have been learned, in a predetermined storage region, and the learning process ends.

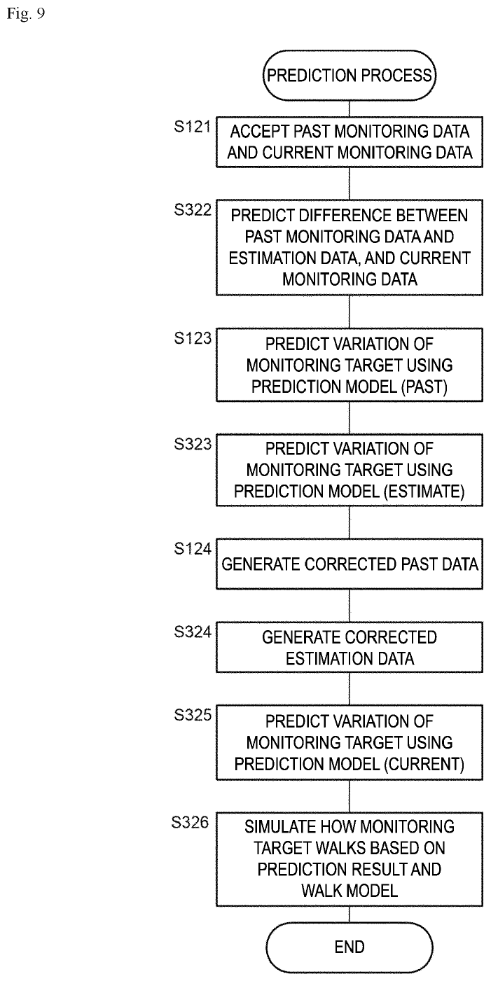

FIG. 9 is a flowchart illustrating a sequence of the prediction process performed by the prediction apparatus 30. The CPU 11 reads the prediction program from the ROM 12 or the storage 14, loads the prediction program onto the RAM 13, and executes the prediction program, whereby the prediction process is performed. Note that the processes that are the same as those the prediction process in the first embodiment (FIG. 5) are denoted by the same step numbers.

In step S121, the CPU 11 operates as the prediction unit 320, and accepts current monitoring data and past monitoring data input to the prediction apparatus 30.

Next, in step S322, the CPU 11 operates as the first prediction unit 321, and predicts a difference between the current monitoring data and each of the past monitoring data and the estimation data using the difference model 311, and acquires the prediction result indicating that the current condition is the regular condition or the irregular condition. Then, the CPU 11 operates as the first prediction unit 321, and passes to each of the first generation unit 123, the second generation unit 223, and the third prediction unit 324, the difference attribute extracted by the difference model 311 during the prediction process for predicting whether the current condition is the regular condition or the irregular condition as well as the prediction result.

Next, in step S123, the CPU 11 operates as the second prediction unit 122, and uses the prediction model (past) 112 to predict variation of the monitoring target at a future time point from the past monitoring data, and passes the prediction result to the third prediction unit 324.

Next in step S323, the CPU 11 operates as the fourth prediction unit 222, and uses the prediction model (estimate) 212 to predict variation of the monitoring target at a future time point from the estimation data, and passes the prediction result to the third prediction unit 324.

Next, in step S124, the CPU 11 operates as the first generation unit 123, and generates corrected past data from the past monitoring data by correcting the difference between the past monitoring data and the current monitoring data, using the difference attribute received from the first prediction unit 321. Then, the CPU 11 operates as the first generation unit 123 and passes the corrected past data thus generated to the third prediction unit 324.

Next, in step S324, the CPU 11 operates as the second generation unit 223, and generates corrected estimation data from the estimation data by correcting the difference between the estimation data and the current monitoring data, using the difference attribute received from the first prediction unit 321. Then, the CPU 11 operates as the second generation unit 223 and passes the corrected estimation data thus generated to the third prediction unit 324.

Next, in step S325, the CPU 11 operates as the third prediction unit 324, and acquires the current monitoring data as well as the prediction result and the difference attribute received from the first prediction unit 321. The CPU 11 operates as the third prediction unit 324, and acquires the prediction result received from the second prediction unit 122 and the prediction result received from the fourth prediction unit 222. The CPU 11 operates as the third prediction unit 324, and acquires corrected past data received from the first generation unit 123 and corrected estimation data received from the second generation unit 223. Then, the CPU 11 operates as the third prediction unit 324, and predicts the variation of the monitoring target at a future time point using the acquired information and the prediction model (current) 313, when the prediction result received from the first prediction unit 321 indicates the irregular condition.

Next, in step S326, the CPU 11 operates as the third prediction unit 124, and outputs the prediction result output from the prediction model (current) 313 as the final prediction result. The CPU 11 operates as the third prediction unit 124, and outputs the prediction result received from the second prediction unit 122, the prediction result received from the fourth prediction unit 222, or a prediction result as a result of combining these prediction results, as the final prediction result, when the prediction result received from the first prediction unit 321 indicates the regular condition. Then, the CPU 11 operates as the simulation unit 330, and based on the prediction result output from the third prediction unit 324 and the walk model 314, simulates how a pedestrian, which is an example of the monitoring target, walks and outputs the simulation result. Then, the prediction process ends.

As described above, the prediction apparatus according to the third embodiment learns in advance, a difference model for predicting whether the current condition is the regular condition or the irregular condition based on the difference between the current monitoring data and each of the past monitoring data and the estimation data. The corrected past data is generated as a result of correcting the difference between the past monitoring data and the current monitoring data, and the corrected estimation data is generated as a result of correcting the difference between the estimation data and the current monitoring data. Then, a prediction model (current) is learned in advance for predicting variation of the monitoring target, by using the corrected estimation data and the corrected past data. Then, at the time of prediction, when the current condition is predicted to be the irregular condition, the corrected past data and the corrected estimation data are generated and the variation of the monitoring target is predicted using the corrected past data, the corrected estimation data, and the prediction model (current). With this configuration, the variation of the monitoring target can be appropriately predicted even when the monitoring target involves irregular variation.

Note that in the above-described embodiments, the configuration in which the prediction apparatus includes the learning unit and the prediction unit is described, but the learning unit and the prediction unit may each be implemented by another computer.

Note that the prediction process which is performed by causing the CPU to read and execute the software (program) in the above-described embodiments may be performed by various processors other than the CPU. Examples of the processor in such a case include a programmable logic device (PLD) such as a field-programmable gate array (FPGA) the circuit configuration of which can be changed after manufacturing, a dedicated electric circuit such as an application specific integrated circuit (ASIC) that is a processor having a circuit configuration designed dedicatedly for executing the specific processing, and the like. Further, the prediction process may be performed by one of these various processors or a combination of two or more processors of the same type or different types (such as, for example, a combination of a plurality of FPGAs and a combination of a CPU and an FPGA). More specifically, the hardware structure of such various processors is an electrical circuit obtained by combining circuit devices such as semiconductor devices.

In each of the embodiments described above, although a form in which the prediction program is stored (installed) in the ROM 12 or the storage 14 in advance has been described, the form is not limited thereto. The program may be provided in the form of being stored in a non-transitory storage medium such as a compact disc read only memory (CD-ROM), a digital versatile disc read only memory (DVD-ROM), a Blu-ray disc, or a universal serial bus (USB) memory. The program may be in a form that is downloaded from an external apparatus via a network.

Relating to each of the embodiments described above, the following supplementary notes are disclosed.

Supplementary Note 1

A learning apparatus comprising:
a memory; and
at least one processor connected to the memory,
the processor being configured to
learn a first model for predicting a difference between current monitoring data that is monitoring data obtained by monitoring a monitoring target at each time point and at each of a plurality of monitoring points and is monitoring data at a current time point, and past monitoring data that is monitoring data at each of a plurality of past time points;
learn a second model for predicting variation of the monitoring target using the past monitoring data;
generate first corrected data from the past monitoring data, by correcting a difference between the past monitoring data and the current monitoring data, using the first model; and
learn a third model for predicting variation of the monitoring target using the current monitoring data, the first model, the second model, and the first corrected data.

Supplementary Note 2

A non-transitory recording medium storing a program executable by a computer to execute a learning process, the learning process comprising:
learning a first model for predicting a difference between current monitoring data that is monitoring data obtained by monitoring a monitoring target at each time point and at each of a plurality of monitoring points and is monitoring data at a current time point, and past monitoring data that is monitoring data at each of a plurality of past time points;
learning a second model for predicting variation of the monitoring target using the past monitoring data;
generating first corrected data from the past monitoring data, by correcting a difference between the past monitoring data and the current monitoring data, using the first model; and
learning a third model for predicting variation of the monitoring target using the current monitoring data, the first model, the second model, and the first corrected data.

### REFERENCE SIGNS LIST

10, 20, 30 Prediction apparatus
11 CPU
12 ROM
13 RAM
14 Storage
15 Input unit
16 Display unit
17 Communication I/F
19 Bus
100, 200, 300 Learning unit
101, 201, 301 First learning unit
102 Second learning unit
103 First generation unit
104, 204, 304 Third learning unit
111, 211, 311 Difference model
112 Prediction model (past)
113, 213, 313 Prediction model (current)
120, 220, 320 Prediction unit
121, 221, 321 First prediction unit
122 Second prediction unit
123 First generation unit
124, 224, 324 Third prediction unit
202 Fourth learning unit
203 Second generation unit
212 Prediction model (estimate)
222 Fourth prediction unit
223 Second generation unit
314 Walk model
330 Simulation unit

1. A learning apparatus comprising a circuit configured to execute a method comprising:
learning a first model for predicting a difference between current monitoring data that is monitoring data obtained by monitoring a monitoring target at each time point and at each of a plurality of monitoring points and is monitoring data at a current time point, and past monitoring data that is monitoring data at each of a plurality of past time points;
learning a second model for predicting variation of the monitoring target using the past monitoring data;
generating first corrected data from the past monitoring data, by correcting a difference between the past monitoring data and the current monitoring data, using the first model; and
learning a third model for predicting variation of the monitoring target using the current monitoring data, the first model, the second model, and the first corrected data.

2. The learning apparatus according to claim 1, wherein
the learning the first model uses estimation data obtained by estimating monitoring data at each of a plurality of time points,
the circuit further configured to execute a method comprising:
generating second corrected data from the estimation data, by correcting a difference between the estimation data and the current monitoring data, using the first model; and
learning a fourth model for predicting variation of the monitoring target using the estimation data, and
learning the third model further using the second corrected data and the fourth model.

3. The learning apparatus according to claim 1, the circuit further configured to execute a method comprising:
learning estimation data obtained by estimating monitoring data at each of a plurality of time points;
learning a fourth model for predicting variation of the monitoring target using the estimation data;
generating second corrected data from the estimation data, by correcting a difference between the estimation data and the current monitoring data, using the first model; and
learning a third model for predicting variation of the monitoring target using a combination of at least the current monitoring data, the first model, the fourth model, and the second corrected data.

4-5. (canceled)

6. A computer-implemented method for learning, the method comprising:
learning a first model for predicting a difference between current monitoring data that is monitoring data obtained by monitoring a monitoring target at each time point and at each of a plurality of monitoring points and is monitoring data at a current time point, and past monitoring data that is monitoring data at each of a plurality of past time points;
learning a second model for predicting variation of the monitoring target using the past monitoring data;
generating first corrected data from the past monitoring data, by correcting a difference between the past monitoring data and the current monitoring data, using the first model; and
learning a third model for predicting variation of the monitoring target using the current monitoring data, the first model, the second model, and the first corrected data.

7. A computer-implemented method for learning, the method comprising:
learning a first model for predicting a difference between current monitoring data that is monitoring data obtained by monitoring a monitoring target at each time point and at each of a plurality of monitoring points and is monitoring data at a current time point, and estimation data obtained by estimating monitoring data at each of a plurality of time points;
learning a fourth model for predicting variation of the monitoring target using the estimation data;
generating second corrected data from the estimation data, by correcting a difference between the estimation data and the current monitoring data, using the first model; and
learning a third model for predicting variation of the monitoring target using the current monitoring data, the first model, the fourth model, and the second corrected data.

8. (canceled)

9. The learning apparatus according to claim 1, wherein the monitoring data includes a location of the monitoring target.

10. The learning apparatus according to claim 1, wherein the learning the third model using the difference between the past monitoring data and the current monitoring data corrects predicting the variation of the monitoring target under an irregular condition.

11. The learning apparatus according to claim 1, wherein the monitoring target includes a person entering and exiting a predetermined area.

12. The learning apparatus according to claim 1, wherein the plurality of monitoring points include a gate where a person passes through.

13. The computer-implemented method according to claim 6, wherein
the learning the first model uses estimation data obtained by estimating monitoring data at each of a plurality of time points,
the method further comprising:
generating second corrected data from the estimation data, by correcting a difference between the estimation data and the current monitoring data, using the first model; and
learning a fourth model for predicting variation of the monitoring target using the estimation data, and
learning the third model further using the second corrected data and the fourth model.

14. The computer-implemented method according to claim 6, the method further comprising:
learning a fourth model for predicting variation of the monitoring target using estimation data;
generating second corrected data from the estimation data, by correcting a difference between the estimation data and the current monitoring data, using the first model; and
learning a third model for predicting variation of the monitoring target using a combination of at least the current monitoring data, the first model, the fourth model, and the second corrected data.

15. The computer-implemented method according to claim 6, wherein the monitoring data includes a location of the monitoring target.

16. The computer-implemented method according to claim 6, wherein the learning the third model using the difference between the past monitoring data and the current monitoring data corrects predicting the variation of the monitoring target under an irregular condition.

17. The computer-implemented method according to claim 6, wherein the monitoring target includes a person entering and exiting a predetermined area.

18. The computer-implemented method according to claim 6, wherein the plurality of monitoring points include a gate where a person passes through.

19. The computer-implemented method according to claim 7, wherein the first model extracts an attribute that quantitatively indicates a difference between the current monitoring data and the past monitoring data as a prediction result and indicates whether the current monitoring data represents a regular condition or an irregular condition.

20. The computer-implemented method according to claim 7, wherein the learning the third model using the difference between the past monitoring data and the current monitoring data corrects predicting the variation of the monitoring target under an irregular condition.

21. The computer-implemented method according to claim 7, wherein the monitoring target includes a person entering and exiting a predetermined area.

22. The computer-implemented method according to claim 7, herein the plurality of monitoring points include a gate where a person passes through.

23. The computer-implemented method according to claim 7, wherein the first model extracts an attribute that quantitatively indicates a difference between the current monitoring data and the past monitoring data as a prediction result and indicates whether the current monitoring data represents a regular condition or an irregular condition.
